(19) United States
(12) Patent Application Publication
(10) Pub. No.: US 2011/0256921 A1
(43) Pub. Date: Oct. 20, 2011

(54) SYSTEM AND METHOD FOR INTERACTIVE 3D GAMING

(76) Inventors: Larry Pacey, Chicago, IL (US); Jeremy Hornik, Chicago, IL (US)

(21) Appl. No.: 13/174,242

(22) Filed: Jun. 30, 2011

Related U.S. Application Data
(63) Continuation of application No. 11/664,400, filed on Jun. 8, 2009.
(60) Provisional application No. 60/615,126, filed on Oct. 1, 2004.

(51) Int. Cl. A63F 9/24; A63F 13/00

(52) U.S. Cl. 463/20; 463/32; 463/42

(57) ABSTRACT

Embodiments include a method of displaying a gaming outcome in a gaming machine. The method includes displaying an image having two or more picks to a player, wherein at least one pick is hidden; receiving an indication of the pick selected by the player; modifying the image to reflect the pick selected by the player; and revealing one or more hidden picks.

### PRIORITY APPLICATIONS

This application is a continuation of U.S. application Ser. No. 11/664,400, filed Jun. 8, 2009, which is a U.S. National Stage Filing under 35 U.S.C. 371 from International Patent Application Serial No. PCT/US2005/034847, filed Sep. 27, 2005, and published on Apr. 13, 2006 as WO 2006/039348 A1, which claims the priority benefit of U.S. Provisional Application Ser. No. 60/615,126 filed Oct. 1, 2004, the contents of which are incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2005, WMS Gaming Inc. All Rights Reserved.

### BACKGROUND OF THE INVENTION

1. Field of the Invention

This patent application pertains generally to gaming systems, and more particularly, but not by way of limitation, to a system and method for displaying three-dimensional pick games and effects in a gaming machine.

2. Background Information

Video gaming machines are popular within the gaming industry. They typically are operable to play traditional games such as slots, poker, bingo, keno and blackjack. Such machines have been enhanced in recent years by adding effects that make them more attractive, exciting and entertaining.

Pick games are a popular type of game. In a pick game, the player chooses from a number of selections. The selection then triggers particular gaming outcomes. Pick games are either used alone, or in combination with reel-based games to provide bonus events. Bonus events occur outside the reel spin, injecting either a random event or fostering some player interaction to trigger a random event.

The graphical capabilities of processors have increased dramatically over the last decade. At the same time, there is a continuing need to develop new and exciting effects for video gaming machines. What is needed is a way of harnessing the graphics power of processors to introduce new and innovative pick games in video gaming machines.

### BRIEF DESCRIPTION OF THE DRAWINGS

FIG. 1 illustrates a gaming machine according to the present invention;

FIG. 2 is a block diagram of a control system suitable for operating the gaming machine of FIG. 1;

FIGS. 3 and 4 illustrate a pick game based on revelation through layering according to the present invention;

FIG. 5 illustrates a pick game based on simulation of physical events according to the present invention;

FIG. 6 illustrates a pick game based on movement of a three-dimensional character through an environment according to the present invention; and

FIG. 7 illustrates a pick game based on interaction of two three-dimensional characters according to the present invention.

### DETAILED DESCRIPTION OF THE INVENTION

In the following detailed description of the preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

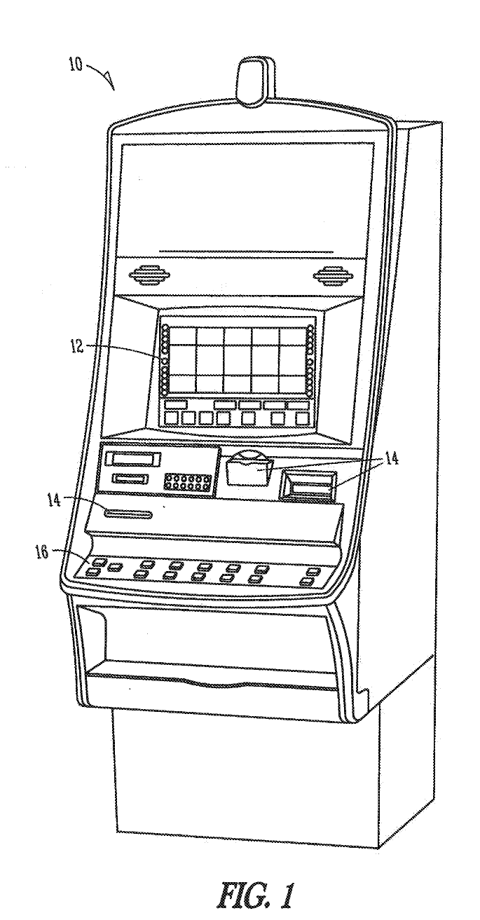

FIG. 1 illustrates an exemplary video gaming machine 10, also referred to as a Video Lottery Terminal (VLT), in which embodiments of the invention may be implemented. In some embodiments, gaming machine 10 is operable to conduct a wagering game such as mechanical or video slots, poker, keno, bingo, or blackjack. The gaming machine 10 shown in FIG. 1 includes a video display 12 such as a cathode ray tube (CRT), liquid crystal display (LCD), plasma, or other type of video display known in the art. In one such embodiment, a touch screen overlies the display 12. In the illustrated embodiment, the gaming machine 10 is an “upright” version in which the display 12 is oriented vertically relative to a player. Alternatively, the gaming machine may be a “slant-top” version in which the display 12 is slanted at about a thirty-degree angle toward the player.

Gaming machine 10 includes one or more credit receiving mechanisms 14 for receiving credits to be used for placing wagers in the game. The credit receiving mechanisms 14 may, for example, include a coin acceptor, a bill acceptor, a ticket reader, and a card reader. The bill acceptor and the ticket reader may be combined into a single unit. The card reader may, for example, accept magnetic cards and smart (chip) cards coded with money or designating an account containing money. In some embodiments, credit receiving mechanism 14 receives credits through a network interface.

In some embodiments, the gaming machine 10 includes a user interface comprising a plurality of push-buttons 16, the above-noted touch screen, and other possible devices. The plurality of push-buttons 16 may, for example, include one or more “bet” buttons for wagering, a “play” button for commencing play, a “collect” button for cashing out, a help” button for viewing a help screen, a “pay table” button for viewing the pay table(s), and a “call attendant” button for calling an attendant. Additional game specific buttons may be provided to facilitate play of the specific game executed on the machine. The touch screen may define touch keys for implementing many of the same functions as the push-buttons. Other possible user interface devices include a keyboard and a pointing device such as a mouse or trackball.

A processor controls operation of the gaming machine 10. In response to receiving a wager and a command to initiate play, the processor randomly selects a game outcome from a plurality of possible outcomes and causes the display 12 to depict indicia representative of the selected game outcome. In the case of slots for example mechanical or simulated slot reels are rotated and stopped to place symbols on the reels in visual association with one or more pay lines. If the selected outcome is one of the winning outcomes defined by a pay table, the processor awards the player with a number of credits associated with the winning outcome.

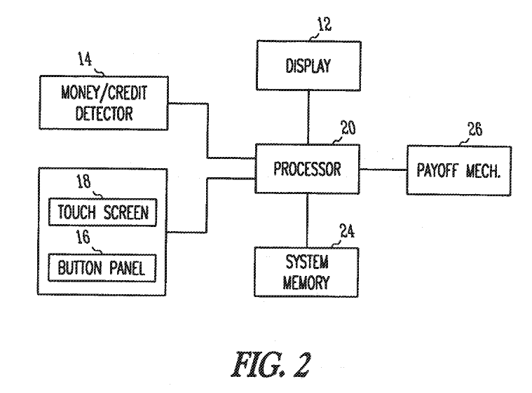

FIG. 2 is a block diagram of a control system suitable for operating the gaming machine 10. Money/credit detector 22 signals a processor 20 when a player has inserted money, tickets, tokens, cards or other mechanism for obtaining credits for plays on the gaming machine through credit mechanisms 14. Using a button panel 16 and/or a touch screen 18, the player may select any variables associated with the wagering game and place his/her wager to purchase a play of the game. In a play of the game, the processor 20 generates at least one random event using a random number generator (RNG) and provides an award to the player for a winning outcome of the random event.

Alternatively, the random event may be generated by a remote computer using an RNG or pooling schema and then transmitted to the gaming machine. The processor 20 operates the display 12 to represent the random event(s) and outcome(s) in a visual form that can be understood by the player. In addition to the processor 20, the control system may include one or more additional slave control units for operating the display 12 and any secondary displays.

System memory 24 stores control software, operational instructions and data associated with the gaming machine. In one embodiment, the system memory 24 comprises a separate read-only memory (ROM) and battery-backed random-access memory (RAM). However, it will be appreciated that the system memory 24 may be implemented on any of several alternative types of memory structures or may be implemented on a single memory structure.

A payoff mechanism 26 is operable in response to instructions from the processor 20 to award a payoff to the player. The payoff may, for example, be in the form of a number of credits. The number of credits is determined by one or more math tables stored in the system memory 24.

In one embodiment, gaming machine 10 includes a three-dimensional pick game.

Three dimensional effects have been used in previous gaming machines. Effects to date have, however, relied on pre-rendered presentations of three-dimensional images. The use of pre-rendered images limits the types of user interaction that could be handled and, therefore, was view as somewhat gimmicky. Gaming machines 10 according to the present invention generate their three-dimensional effects in real-time. The result is a much more interactive and interesting environment for the gaming player.

In one embodiment, the three-dimensional pick games are implemented using a game design package such as RenderWare Studio 2.0 running, for example, on a processor designed by Intel or AMD.

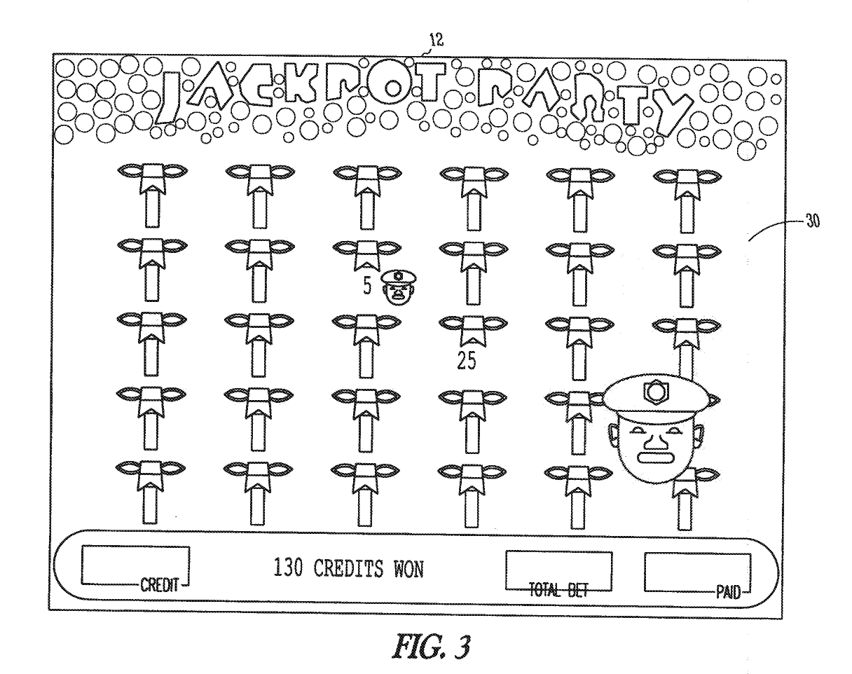

One three-dimensional pick game effect is revelation through layering. An embodiment of such an effect is shown in FIG. 3, where a three-dimensional game displays selections (i.e., presents 30) in a three-dimensional array. That is, there are presents behind the presents 30 shown in FIG. 3. Presents 30 when chosen clear to reveal more presents behind them. Players can dig on any revealed layer. In one such embodiment, the depth of presents in any cell of the array is determined in a random manner.

In one embodiment, as is shown in FIG. 4, processor 20 displays an image at 40 having two or more picks, including one or more picks hidden behind other picks. Processor 20 receives the player's pick at 42 and determines a gaming outcome at 44 as a function of the player's pick. Processor 20 then reveals one or more of the hidden picks.

In another revelation through layering embodiment, matching sets vanish to reveal more picks. An example in a non-gaming sense might be the game Mah-Jongg. A cascade game could be constructed using this approach as well.

Another three-dimensional pick game effect is lighting. In one embodiment, the angle of light hitting the object determines its value. In one such embodiment, players choose one of a set of pyramids. This selection would reveal the four sides of the pyramid, each having a different value. The sun then strikes the pyramid from one side awarding that value. In one embodiment, the sun's position is fixed in advance of the player's choice; in another embodiment, the sun's position randomly moves to a side after the player's selection.

In another lighting embodiment, lighting changes over time, or after a random or predetermined number of picks. The change in lighting reveals new picks and hides other picks. In one such embodiment, lighting changes over time alter the value of chosen wins, or turn some losing choices into prizes, and vice versa.

In another lighting embodiment, light falls on a sun dial or a crystal. In one embodiment, the light striking the sun dial or crystal enhances or diminishes certain prizes. In another embodiment, the light striking the sun dial or crystal reveals new picks and hides other picks.

In another lighting embodiment, lighting changes over time, or after a random or predetermined number of picks. The change in lighting reveals new picks and hides other picks. In one such embodiment, lighting changes over time alter the value of chosen wins, or turn some losing choices into prizes, and vice versa.

In another lighting embodiment, the player is in a cave having fissures. Players make a pick by shining a light into a particular fissure. Similar games can be constructed where the player directs light into a void in order to make a pick.

Another three-dimensional pick game effect is the rotation of objects. In one such embodiment, picks have multiple sides, like dice. Picking an object makes the object rotate until one side is facing outwards, awarding that side.

In another rotation of objects embodiment, picks are arranged on a three-dimensional object. The player rotates the object until he or she finds a pick they like. In one such embodiment, the player can only rotate the object if he or she has reached a certain level (either through clearing all picks in a previous level, finding a “move along” pick, etc.).

Another three-dimensional pick game effect is immersion. The player is immersed in the scene, such as a room and the player is placed in the middle of the room. Players can rotate the room around themselves to see more pick opportunities. Once again, the amount of rotation could be limited based on the player's level as noted above.

Another three-dimensional pick game effect is the use of volume and fluids. In one embodiment, players choose spouts to pour into various containers. When a container is full, its value is awarded. In one such embodiment, liquid moves randomly over a playfield before settling in a container.

In one fluid-based embodiment, fluids build up over a series of picks. Another pick causes the vessel to explode, spraying the fluid over a range of prizes. All splattered prizes are awarded.

In another fluid-based embodiment, sponges are displayed within display 12. Each sponge absorbs different amounts of fluids, awarding different prizes.

In another fluid-based embodiment, the bonus begins with a mostly submerged playfield. Some picks award prizes. Others make the playfield drain, revealing additional picks and prizes.

Another three-dimensional pick game effect is the real-time simulation of physical events. In one embodiment, picking one of a number of doors causes a set number of marbles to drop through a course. The final marble destination reveals the award.

In one such embodiment, marbles come in different sizes; each size can potentially reach different levels. So the largest marble will be blocked from advancing to a later level by a small gate. Players are randomly assigned balls of different sizes by pick, or by chance.

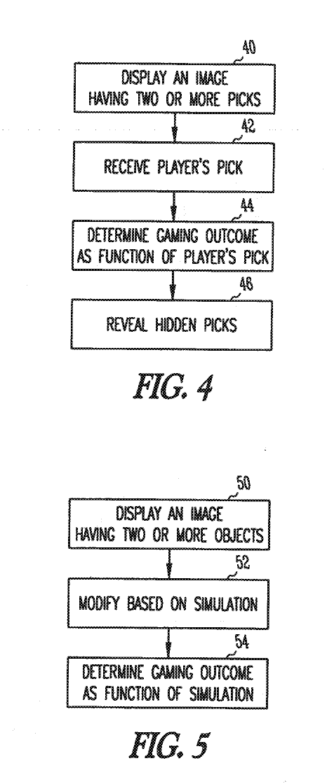

In one embodiment, as is shown in FIG. 5, processor 20 displays an image at 50 having two or more objects. Processor 20 simulates movement by one or more of the objects at 52 and determines a gaming outcome at 54 as a function of the simulation.

In another embodiment based on real-time simulation of a physical event, a player directs an air hockey-style puck around a course. The goal it drops into determines the payout. The player chooses the puck's initial direction, velocity, or both. In different embodiments, the player touches, plucks or shoots the puck by touching touch screen 18. In some of these embodiments, a random power factor is added to remove the effects of skill.

In another embodiment based on real-time simulation of a physical event, an explosion is simulated. In one such embodiment, a player is represented on screen by an avatar (say, a wizard.) The player chooses a treasure chest and directs an explosive spell on the chest. The chest explodes and disgorges a predetermined number of jewels. Any jewels that land within the wizard's reach are awarded to the player.

In one such embodiment, certain picks increase the wizard's reach. For instance, some objects are not reachable through picks, but only through an expansion of reach. In another such embodiment, jewels may be drawn to the wizard as if by gravity following the explosion.

In one such embodiment, other chests explode when struck by jewels, or by sparks from the explosive spell, causing a chain reaction.

In another embodiment based on real-time simulation of a physical event, a catapult is simulated. In one such embodiment, a player chooses a number of factors on a catapult, e.g., angle of shot, strength of spring, etc. The shot then moves in a manner determined by the player's choices to reveal an outcome (closeness to a target, which target is hit, etc.) An additional random factor (for example, wind) might be needed to correct the problems of skill.

A variation on explosions is overlapping. When a pick is made, an object may randomly expand. If it does, all object it overlaps are awarded. In one such embodiment, subsequent objects also expand in a chain reaction.

In another embodiment based on real-time simulation of a physical event, the action of dominoes is simulated. In one such embodiment, prizes are objects that are randomly set in an environment. Picking an object knocks it over. Any objects also knocked over in its fall are also awarded. (Example: Godzilla and Tokyo skyscrapers.)

Prizes can be given attributes. In one embodiment, some objects are sticky (or magnetic, etc.). Sticky objects make any awards they come into contact with stick to them, and award those prizes. In one embodiment, a character is directed by the player to walk around a room full of objects coated with Velcro. Prizes randomly stick to the character and are awarded to the player.

In another embodiment, magnetic objects draw prizes to them. They can also do it subject to characteristics, e.g., the magnet only draws metal awards like gold and silver, but not gems. In one such embodiment, only prizes are drawn, not poopers.

In another embodiment based on real-time simulation of a physical event, friction is simulated. In one such embodiment, players remove prizes from a stack. The pieces have a random amount of friction associated with them. If the pile is disturbed and collapses, the bonus is over. A similar game uses a weight randomly assigned to each object to achieve the same goal.

Another three-dimensional pick game effect is range to an object. In one embodiment, a player alters the volatility of the event by moving closer to or further from the target. In one such embodiment, values on the target change dynamically as the player increases and decreases the range.

The risk/reward of other tasks can be changed as well, with the player changing volatility by making choices to make the task harder (examples: in miniature golf by making course alterations, in H-O-R-S-E by altering shot difficulty and distance, in weightlifting by selecting different weights, in jumping a line of buses on a motorcycle by increasing the number of buses in the line, in running by altering the terrain of the course, in drinking contests by selecting different volumes of liquids, in water races by varying the current, and in pachinko by changing the size of the ball). Pick games can be designed based on any of these types of simulations.

In one series of embodiments, games are designed based on the interaction of three-dimensional characters with a three-dimensional environment. In one such embodiment, a penguin walks over a series of ice blocks. The player picks ice blocks for the penguin to walk over. Picking will put some cracks in the ice, and award a prize. The bonus ends when a pick makes the ice break, and the penguin falls through the hole in the ice.

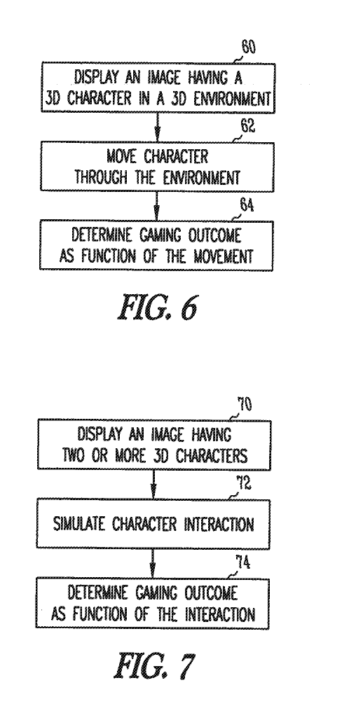

In one embodiment, as is shown in FIG. 6, processor 20 displays an image at 60 having a three-dimensional character within a three-dimensional environment. Processor 20 simulates movement of the character within the environment at 62 and determines a gaming outcome at 64 as a function of the movement.

In one such embodiment, a walrus is trapped in the ice. If the walrus is freed, he chases the penguin off, ending the bonus.

In another such embodiment, at random times a whale under the ice is revealed after the ice breaks. The whale blows up water, which freezes, recreating the ice field and extending the bonus.

In one embodiment of a game based on the interaction of three-dimensional characters with a three-dimensional environment, a character that digs, such as a miner or a gopher, digs a series of tunnels to reveal prizes.

In another embodiment of a game based on the interaction of three-dimensional characters with a three-dimensional environment, a character stacks picks, such as boxes in a warehouse. The higher the stack, the bigger the prize.

In another embodiment of a game based on the interaction of three-dimensional characters with a three-dimensional environment, a character changes the course of a physical event. For example, a dropped marble might be caught by an ant and carried over to a different place. Or the character might change the layout of the environment. For example, in a marble drop, a character might put an obstacle in front of the lowest prize, or dig a trench that makes marbles go directly to the highest prize.

In another embodiment of a game based on the interaction of three-dimensional characters with a three-dimensional environment, characters interact with picks to set value: For example, in one embodiment of a game with a multisided pick, the player selects one of the picks, and then a character rotates the pick until a value is revealed.

In another such embodiment, a character is shown in a map view, going through an environment. When the character happens across a mini-bonus, the mini-bonus is zoomed into, expanding it into the player's full view. The mini-bonus has the character interact with that environment.

Finally, in a variation of the Dominos game described above, in one embodiment, characters randomly or as directed knock over objects. If a prize knocks over another prize in its fall, both are awarded.

In one series of embodiments, games are designed based on the interaction of three-dimensional characters with other three-dimensional characters. In one such embodiment, the player chooses the action a character will perform next. A computer randomly picks an action for a second character. The two characters then interact to create a result. For example, the player chooses that a boxer throw a high punch. The computer chooses that his opponent defends low. The result is that the player's punch hits and the player is awarded a prize, or granted entry to another bonus event.

In one embodiment, as is shown in FIG. 7, processor 20 displays an image at 70 having two or more three-dimensional characters within a three-dimensional environment. Processor 20 simulates interaction of the characters at 72 and determines a gaming outcome at 74 as a function of the interaction.

In one embodiment, there are three or more characters and the player only controls one of the characters.

In one embodiment, characters can either help or hinder you.

In one embodiment, the player chooses a number of actions in a row (e.g., a combination of punches). The results of all the actions play out in order, and then the player has another chance to choose a new set of actions.

In one embodiment, the other character's actions are not chosen by the computer, but by another player, either on the same device or by networking two or more gaming machines 10 together.

In some embodiments of the pick games described above, a player's skill has an effect on the gaming outcome. In other embodiments, the outcome is random. That is, skill has no bearing on the result.

In the above discussion, the term “processor” is defined to include any digital or analog data processing unit. Examples include any microprocessor or microcontroller capable of embodying the inventions described herein.

Examples of articles comprising machine readable media are floppy disks, hard drives, CD-ROM or DVD media or any other read-write or read-only memory device.

Portions of the above description have been presented in terms of algorithms and symbolic representations of operations on data bits within a computer memory.

These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is intended that this invention be limited only by the claims and the equivalents thereof.

What is claimed is:

1. A method of conducting a wagering game, the method comprising:
receiving, responsive to an input via one or more input devices, a wager from the player;
displaying, via at least one display device, a plurality of three-dimensional game elements of an interactive picking game via real-time-rendered three-dimensional imagery, the plurality of game elements including at least two pickable elements;
receiving, via the one or more input devices, a player selection of one of the at least two pickable elements;
determining, via one or more processors, a game outcome based on the picked element; and
revealing, via the display device, another element, the another element having been at least partially obscured by the picked element prior to the player selection.

2. The method of claim 1, wherein the interactive picking game is a bonus game.

3. The method of claim 1, wherein the interactive picking game is a basic game.

4. The method of claim 1, wherein revealing another element comprises moving the picked element from in front of the another element.

5. The method of claim 1, wherein the picked element vanishes to reveal the another element.

6. The method of claim 1, wherein the plurality of three-dimensional game elements comprises one or more subsets of related game elements, and wherein a player pick of an element of one of the one or more subsets causes all the related elements of the one of the one or more subsets to vanish.

7. The method of claim 1, wherein revealing another element comprises rotating the picked element and the another element such that the picked element and the another element exchange positions.

8. The method of claim 1, wherein the plurality of three-dimensional game elements is displayed as a three-dimensional array.

9. The method of claim 1, wherein the plurality of three-dimensional game elements is displayed as at least one row of game elements with a frontmost element of the at least one row being a pickable element.

10. The method of claim 9, wherein picking the frontmost element removes the picked element to reveal a next element in the at least one row.

11. The method of claim 1, wherein the picked element has an award value and the award value is awarded to the player.

12. The method of claim 11, wherein the another element has another award value and the another award value is awarded to the player.

13. A gaming system conducting a wagering game, the gaming system comprising:
at least one display device;
at least one input device;
one or more processors,
at least one memory device storing instructions that, when executed by the one or more processors, cause the one or more processors to operate with the at least one display device and the at least one input device to
receive, responsive to an input via the at least one input device, a wager from the player;
display a plurality of three-dimensional game elements of an interactive picking game via real-time-rendered three-dimensional imagery, the plurality of game elements including at least two pickable elements;
receive a player selection of one of the at least two pickable elements;
determine a game outcome based on the picked element; and
reveal another element, the another element having been at least partially obscured by the picked element.

14. The gaming system of claim 13, wherein the interactive picking game is a bonus game.

15. The gaming system of claim 13, wherein the interactive picking game is a basic game.

16. The gaming system of claim 13, wherein revealing another element comprises moving the picked element from in front of the another element.

17. The gaming system of claim 13, wherein the picked element vanishes to reveal the another element.

18. The gaming system of claim 13, wherein the plurality of three-dimensional game elements comprises one or more subsets of related game elements, and wherein a player pick of an element of one of the one or more subsets causes all the related elements of the one of the one or more subsets to vanish.

19. The gaming system of claim 13, wherein revealing another element comprises rotating the picked element and the another element such that the picked element and the another element exchange positions.

20. The gaming system of claim 13, wherein the plurality of three-dimensional game elements is displayed as a three-dimensional array.

21. The gaming system of claim 13, wherein the plurality of three-dimensional game elements is displayed as at least one row of game elements with a frontmost element of the at least one row being a pickable element.

22. The gaming system of claim 21, wherein picking the frontmost element removes the picked element to reveal a next element in the at least one row.

23. The gaming system of claim 13, wherein the picked element has an award value and the award value is awarded to the player.

24. The gaming system of claim 23, wherein the another element has another award value and the another award value is awarded to the player.

25. A computer-readable, non-transitory medium storing executable instructions that, when executed by a gaming system, cause the gaming system to perform a method of conducting a wagering game including real-time-rendered, three-dimensional visual game elements, the three-dimensional game elements being included in an interactive picking game in which a player selection from a plurality of three-dimensional game elements may determine an award, the method comprising:
receiving, responsive to an input via one or more input devices, a wager from the player;
displaying, via at least one display device, a plurality of three-dimensional game elements of an interactive picking game via real-time-rendered three-dimensional imagery, the plurality of game elements including at least two pickable elements;
receiving, via the one or more input devices, a player selection of one of the at least two pickable elements;
determining, via one or more processors, a game outcome based on the picked element; and
revealing, via the one or more processors operating with the display device, another element, the another element having been at least partially obscured by the picked element.

26. The computer-readable medium of claim 25, wherein revealing another element comprises moving the picked element from in front of the another element.

27. The computer-readable medium of claim 25, wherein the picked element vanishes to reveal the another element.

28. The computer-readable medium of claim 25, wherein the plurality of three-dimensional game elements comprises one or more subsets of related game elements, and wherein a player pick of an element of one of the one or more subsets causes all the related elements of the one of the one or more subsets to vanish.

29. The computer-readable medium of claim 25, wherein the one or more input devices includes a touch screen device positioned over the at least one display device.

30. The computer-readable medium of claim 25, wherein the medium resides on a server connected to the at least one display device and the one or more input devices via a communications network.

31. The computer-readable medium of claim 25, wherein the interactive picking game is a bonus game.
